(19) United States
(12) Patent Application Publication
(10) Pub. No.: US 2022/0115690 A1
(43) Pub. Date: Apr. 14, 2022

(54) ALL SOLID BATTERY

(71) Applicant: Samsung SDI Co., Ltd., Yongin-si (KR)

(72) Inventors: Bokkyu CHOI, Yongin-si (KR); Young Gyoon RYU, Yongin-si (KR); Jaegu YOON, Yongin-si (KR); Eungyeong LEE, Yongin-si (KR); Joowook LEE, Yongin-si (KR)

(21) Appl. No.: 17/450,037

(22) Filed: Oct. 5, 2021

(30) Foreign Application Priority Data
Oct. 12, 2020 (KR) 10-2020-0131333

(51) Int. Cl. H01M 10/0562; H01M 10/0525; H01M 4/04; H01M 4/131; H01M 4/139; H01M 4/62

(52) U.S. Cl. CPC H01M 10/0562; H01M 10/0525; H01M 4/0404; H01M 4/0416; H01M 2004/021; H01M 4/131; H01M 4/139; H01M 4/621; H01M 4/043

(57) ABSTRACT

An all solid battery includes a cell stack including a negative electrode, a solid electrolyte layer, and a positive electrode, a case to accommodate the cell stack, and a buffer material to pressure the cell stack in the case.

### CROSS-REFERENCE TO RELATED APPLICATION

This application claims priority to and the benefit of Korean Patent Application No. 10-2020-0131333, filed in the Korean Intellectual Property Office on Oct. 12, 2020, the entire content of which is incorporated herein by reference.

### BACKGROUND

### 1. Field

The present disclosure relates to an all solid battery. More particularly, the present disclosure relates to an all solid battery including (e.g., accommodating) a cell stack in a case.

### 2. Description of the Related Art

An all solid battery includes a cell stack, which includes a positive electrode, a negative electrode and a solid electrolyte layer interposed between the positive electrode and the negative electrode. In the all solid battery, the solid electrolyte acts as a medium for conducting lithium ions.

In a sulfide all solid battery utilizing deposition and removing (e.g., stripping) reactions of lithium, a cell stack may expend and shrink due to the expansion and shrinkage of the negative electrode. It is desirable (e.g., required) to pressurize (e.g., to apply counterpressure to the cell stack) in order to block or absorb such a volume change as well as to maintain a close contact of the negative electrode, the solid electrolyte layer and the positive electrode.

Thus, buffer materials may be applied (e.g., utilized). When a prismatic all solid battery is fabricated, a cell stack with the buffer material is inserted into a case in which one side of the rectangular shaped case is opened, under the pressurizing (e.g., in the state of being pressurized).

Here, a thickness of the cell stack with the buffer material before pressurizing is larger than a distance between interior walls of the case, and thus it is difficult to insert the cell stack into the case (e.g., without applying pressure).

The above information disclosed in this Background section is only for enhancement of understanding of the background of the present disclosure, and therefore it may contain information that does not form the prior art that is already known to a person of ordinary skill in the art.

### SUMMARY

As aspect according to one or more embodiments is directed toward an all solid battery, in which a negative electrode, a positive electrode, and a solid electrolyte layer are in close contact through continuously pressurizing a cell stack in an insertion state so that the cell stack is easily inserted into a battery case (by changing the thickness of the cell stack), and maintaining the close contact after inserting the cell stack with a buffer material into the case.

As aspect according to one or more embodiments is directed toward an all solid secondary battery in which a thickness of a cell stack is changed before and after inserting the cell stack into the case, by utilizing a thermo-responsive porous polymer sheet.

Still another aspect according to one or more embodiments is directed toward an all solid battery in which a negative electrode, a positive electrode, and a solid electrolyte layer are in close contact through increasing a temperature of a cell stack including a thermo-responsive polymer sheet to cause a volume phase transition at a temperature greater than or equal to a critical temperature, before inserting the cell stack into a battery case, to make a total thickness of the cell stack smaller than a distance between opposite interior walls of the battery case (due to the shrinkage of the polymer sheet, e.g., a porous polymer sheet), and by decreasing the temperature to less than the critical temperature to expand the thickness of the cell stack by expanding the polymer sheet (e.g., porous polymer sheet).

The all solid battery according to one embodiment includes a cell stack including a negative electrode, a solid electrolyte layer, and a positive electrode, a case to accommodate the cell stack, and a buffer material to pressurize the cell stack in the case.

The buffer material may be a thermo-responsive porous polymer sheet.

The buffer material may include a thermo-responsive polymer with a critical temperature (lower critical solution temperature, LCST) of about 50° C. to about 80° C., and for example, may be poly(N-ethylmethacrylamide), poly(propylene glycol), poly(N-cyclopropylacrylamide), or a combination thereof.

The buffer material may be between the cell stack and the case.

The negative electrode may include a negative current collector and a negative active material layer on one side or both sides (e.g., opposite sides) of the negative current collector, and the positive electrode may include a positive current collector and a positive active material layer on one side or both sides of the positive current collector. The solid electrolyte layer may be between the negative active material layer and the positive active material layer, and the buffer material may be between an outmost current collector of the cell stack, and an inside surface of the case.

In some embodiments, the negative electrode may include a negative current collector and a negative active material layer on one side of the negative current collector and not on an opposite side of the negative current collector, and the positive electrode may include a positive current collector and a positive active material layer on both sides of the positive current collector. The solid electrolyte layer may be between the negative active material layer and the positive active material layer, and the buffer material may be between the opposite sides of two adjacent negative current collectors.

The buffer material may be between an outmost negative current collector and an inside surface of the case.

The all solid battery according to one or more embodiments exhibits improved workability of inserting the cell stack into the case, as the cell stack is shrunk and expanded owing to the thickness change of the buffer material. That is, the thermo-responsive porous polymer sheet, depending on the temperature variation, and the all solid battery including the same allow for close contact between the negative electrode, the positive electrode, and the solid electrolyte layer in an inserted state.

### BRIEF DESCRIPTION OF THE DRAWINGS

FIG. 1 is a cross-sectional view of an all solid battery according to a first embodiment.

FIG. 2 is a cross-sectional view of an all solid battery according to a second embodiment.

FIG. 3 is a graph showing capacity retention of the all solid batteries according to Examples 1 and 2 and Comparative Example 1.

### DETAILED DESCRIPTION

The present disclosure will be described more fully hereinafter with reference to the accompanying drawings, in which example embodiments of the disclosure are shown. As those skilled in the art would realize, the described embodiments may be modified in various different ways, all without departing from the spirit or scope of the present disclosure. The drawings and the description are to be regarded as illustrative in nature and not restrictive. Like reference numerals designate like elements throughout the specification.

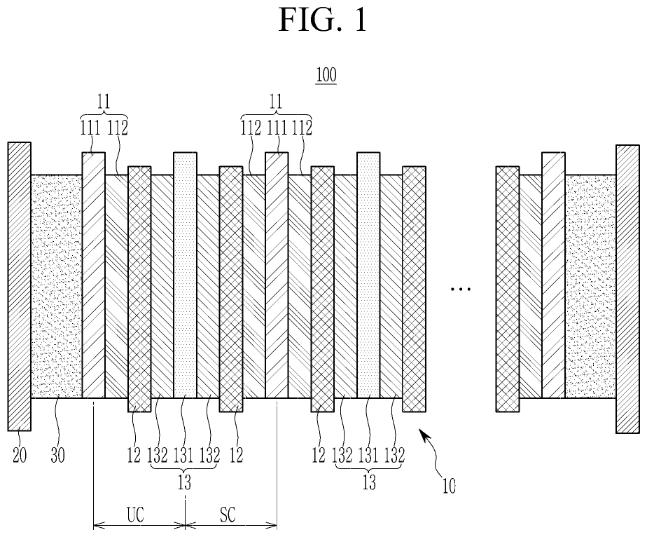

FIG. 1 is a cross-sectional view of an all solid battery according one embodiment. Referring to FIG. 1, the all solid battery 100 according to one embodiment includes a cell stack 10, a case 20, and a buffer material (e.g., a layer of the buffer material or buffer material layer) 30.

The cell stack 10 includes a negative electrode 11, a solid electrolyte layer 12, and a positive electrode 13. The positive electrode 13, the solid electrolyte layer 12, and the negative electrode 11 form a unit cell (UC) with a stacked structure, and the cell stack 10 may include one or a plurality of unit cells (UC) such that a desirable (e.g., necessary) current amount and voltage may be obtained.

The cell stack 10 may expand or shrink due to expansion and shrinkage happening in the negative electrode 11 during charging and discharging. The case 20 accommodates the cell stack 10 and the buffer material 30 positioned inside the case 20 to pressurize the cell stack 10, thereby absorbing the expansion of the cell stack 10. That is, the case 20 exerts pressure to the cell stack 10 to thereby confine the expansion of the cell stack 10. Thus, it allows close contact of the negative electrode 11, the solid electrolyte layer 12, and the positive electrode 13.

The buffer material 30 may include (e.g., be) a thermo-responsive porous polymer sheet of which volume is shrunken (e.g., reduced) at a critical temperature or a temperature higher than the critical temperature, and is expanded (e.g., increased) when the temperature is reduced to be lower than the critical temperature.

The buffer included in the buffer material 30, i.e., the thermo-responsive polymer, may be a thermo-responsive polymer having a critical temperature of about 50° C. to about 80° C. If a polymer having a critical temperature of more than 80° C. is utilized as the thermo-responsive polymer, it is not desired because cell deterioration may occur.

The thermo-responsive polymer may be polymers of which volume is reduced at a critical temperature, and for example, may be poly(N-ethylmethacrylamide), poly(propylene glycol), poly(N-cyclopropylacrylamide), or combination thereof.

When the thermo-responsive polymer having a critical temperature of about 50° C. to about 80° C. is utilized as the buffer included in the buffer material (e.g., in the buffer material layer), the total thickness of the assembly of the cell stack and the buffer material layer is largely maintained compared to the battery case at room temperature. For example, the total thickness of the assembly of the cell stack and the buffer material layer at room temperature may be greater than the thickness of the battery case. Before inserting the assembly of the cell stack and the buffer material layer into the battery case, and when the assembly is heated at a temperature equal to or greater than the critical temperature, the total thickness of the cell stack and the buffer material layer is reduced (e.g., to be less than the thickness of the battery case). Thus, the inserting into the battery case is performed at a temperature equal to or greater than the critical temperature to allow easy insertion of the assembly into the battery case.

Furthermore, when the all solid battery is charged, an inner temperature of the battery is reduced to equal to or less than the critical temperature, and thus, the volume of the assembly may be restored (e.g., to be enlarged), but it does not increase to more than the thickness of the battery case. Thus, the pressurization of the cell stack occurs, so that the contact between the positive electrode, the solid electrolyte layer, and the negative electrode may be improved. As a result, the charging and the discharging of the battery may further readily occur.

When a thermo-responsive polymer having a critical temperature out of the above described range, for example, when the polymer having a critical temperature of less than 50° C. is utilized, a volume of an assembly is not increased at an operation temperature of the all solid battery, which is 25° C. to 45° C., and thus, pressurization cannot be suitably applied to the cell stack. When the polymer has a critical temperature of more than 80° C., a heat-treatment for reducing the volume of the assembly is performed at extremely high temperatures, which cause deterioration of the physical properties, especially, of the solid electrolyte layer.

The all solid battery may undergo expansion and shrinkage of the negative electrode during the charging and the discharging, and thus, it generally includes a buffer material to absorb changes in volume. Furthermore, the thickness of the assembly including the buffer material and the cell stack may be larger than that of the battery case so that the buffer material may be pressurized to improve the contact state between the active material layer and the solid electrolyte. However, in this case, the larger thickness of the assembly than the battery case may cause damage to the assembly during the insertion into the battery case, making it difficult to insert.

As the all solid battery according to one embodiment includes a thermo-responsive polymer as the buffer material, the thickness of the assembly may be reduced to be similar to that of the battery case during insertion, and after insertion, the thickness of the battery may be increased during charging and discharging. As such an increase in the battery thickness (e.g., during charging and discharging) occurs inside the battery case, it causes pressurization, that is, it exerts pressure on the cell stack.

In the all solid battery according to one embodiment, the thickness of the buffer material layer may be about 10 μm to about 300 μm. When the thickness of the buffer material layer is within the above range, the appropriate pressurization may be maintained, which occurs during stable charging and discharging operation of the cell. The thickness of the buffer material layer may be suitably (e.g., surely) and appropriately controlled according to the designed capacity of the positive electrode.

The buffer material layer may be obtained by adding the thermo-responsive polymer to a solvent to prepare a liquid (e.g., a solution) including the buffer material, casting the liquid on a release film, drying the liquid to prepare a buffer material layer, and separating the buffer material layer from the release film. The solvent may be propanol, butanol, ethanol, or a combination thereof. The release film may be a polytetrafluoroethylene film, a polyester film, a silicon release film, or a combination thereof.

In the cell stack 10, the negative electrode 11 may include a negative active material layer 112 on one side or both sides of the negative current collector 111. The negative current collector 111 may be (e.g., formed of) indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be a foil-type or sheet-type (e.g., in the form of a foil or a sheet).

The negative active material layer 112 may include a negative active material, and the negative active material may include (e.g., may be) a carbon-based material and metal particles. The carbon-based material may be amorphous carbon, and the amorphous carbon may be carbon black, acetylene black, denka black, ketjen black, furnace black, activated carbon, or a combination thereof. In some embodiments, the carbon black may be Super P (available from Timcal Co., Ltd.).

The amorphous carbon may have secondary particles in which a plurality of primary particles are agglomerated. In some embodiments, a particle diameter of the primary particles may be about 20 nm to about 100 nm, and a particle diameter of the secondary particles may be about 50 nm to about 1 μm.

In one embodiment, the particle diameter of the primary particles may be about 20 nm or more, about 30 nm or more, about 40 nm or more, about 50 nm or more, about 60 nm or more, about 70 nm or more, about 80 nm or more, or about 90 nm or more, and about 100 nm or less, about 90 nm or less, about 80 nm or less, about 70 nm or less, about 60 nm or less, about 50 nm or less, about 40 nm or less, or about 30 nm or less.

In one embodiment, the particle diameter of the secondary particles may be about 50 nm or more, about 60 nm or more, about 70 nm or more, about 80 nm or more, about 100 nm or more, or about 200 nm or more, and about 1 μm or less, about 900 nm or less, about 800 nm or less, about 700 nm or less, about 600 nm or less, or about 500 nm or less.

The shape of the primary particles may be a spherical shape, an oval shape, a plate shape, or a combination thereof.

The metal particles may be silver (Ag), zinc (Zn), aluminum (Al), tin (Sn), magnesium (Mg), germanium (Ge), copper (Cu), indium (In), nickel (Ni), bismuth (Bi), gold (Au), silicon (Si), platinum (Pt), palladium (Pd), or a combination thereof, and in one embodiment, may be Ag. When the negative active material layer includes the metal particles, the electrical conductivity of the negative electrode may be improved.

The metal particles may have a size of about 5 nm to about 800 nm. In some embodiments, the size may be an average particle diameter (D50). The size of the metal particles may be about 5 nm or more, about 50 nm or more, about 100 nm or more, about 150 nm or more, about 200 nm or more, about 250 nm or more, about 300 nm or more, about 350 nm or more, about 400 nm or more, about 450 nm or more, about 500 nm or more, about 550 nm or more, about 600 nm or more, about 650 nm or more, about 700 nm or more, or about 750 nm or more. The size of the metal particles may be about 800 nm or less, about 750 nm or less, about 700 nm or less, about 650 nm or less, about 600 nm or less, about 550 nm or less, about 500 nm or less, about 450 nm or less, about 400 nm or less, about 350 nm or less, about 300 nm or less, about 250 nm or less, about 200 nm or less, about 150 nm or less, about 100 nm or less, or about 50 nm or less. When the size of the metal particles satisfies in the above ranges, the battery characteristic (for example, the cycle-life characteristic) of the all solid battery may be improved.

When the negative active material layer includes the carbon-based material and the metal particles, the mixing ratio of the carbon-based material and the metal particles may be about 1:1 to about 99:1 by weight ratio. For example, the weight of the carbon-based material may be, based on the metal particles (e.g., based on the weight of the metal particles being 1), about 1 or more, about 2 or more, about 3 or more, about 4 or more, about 5 or more, about 10 or more, about 15 or more, about 20 or more, about 25 or more, about 30 or more, about 35 or more, about 40 or more, about 45 or more, about 50 or more, about 55 or more, about 60 or more, about 65 or more, about 70 or more, about 75 or more, about 80 or more, about 85 or more, about 90 or more or about 95 or more, and about 99 or less, about 95 or less, about 90 or less, about 85 or less, about 80 or less, about 75 or less, about 70 or less, about 65 or less, about 60 or less, about 55 or less, about 50 or less, about 45 or less, about 40 or less, about 35 or less, about 30 or less, about 25 or less, about 20 or less, about 15 or less, about 10 or less, about 5 or less, about 4 or less, about 3 or less, or about 2 or less. For example, the weight ratio of the carbon-based material and the metal particle may be about 1:1 to about 5:1, about 1:1 to about 10:1, about 1:1 to about 20:1, about 1:1 to about 30:1, about 1:1 to about 40:1, about 1:1 to about 50:1, about 1:1 to about 60:1, about 1:1 to about 70:1, about 1:1 to about 80:1, or about 1:1 to about 90:1. When the carbon-based material and the metal particles are included at the above weight ratios, the electrical conductivity of the negative electrode may be further improved.

The binder may be a non-aqueous binder or an aqueous binder.

The non-aqueous binder may be polyvinylidene fluoride, polyvinylchloride, carboxylated polyvinylchloride, polyvinylfluoride, an ethylene oxide-including polymer, polyvinylpyrrolidone, polyurethane, polytetrafluoroethylene, polyethylene, polypropylene, polyamideimide, polyimide, or a combination thereof.

The aqueous binder may be styrene-butadiene rubber (SBR), acrylated styrene-butadiene rubber (ABR), an acrylonitrile-butadiene rubber, an acryl rubber, a butyl rubber, a fluorine rubber, an ethylene oxide-including polymer, polyvinylpyrrolidone, polypropylene, polyepichlorohydrin, polyphosphazene, an ethylene propylene diene copolymer, polyvinylpyridine, chlorosulfonated polyethylene, latex, polyester resin, acryl resin, phenol resin, epoxy resin, polyvinyl alcohol, or a combination thereof.

When the aqueous binder is utilized as a negative electrode binder, a cellulose-based compound (which may impart, e.g., modify, viscosity) may be further utilized as a thickener to provide suitable viscosity. The cellulose-based compound may include one or more of carboxymethyl cellulose, hydroxypropyl methyl cellulose, methyl cellulose, or alkali metal salts thereof. The alkali metal of the alkali metal salts may be Na, K, and/or Li. The thickener may be included in an amount of about 0.1 parts by weight to about 3 parts by weight based on 100 parts by weight of the negative active material.

An amount of the binder may be about 1 wt % about 40 wt % based on the total amount, i.e., 100 wt % of the negative active material layer. The amount of the binder may be, based on the total amount of 100 wt % of the negative active material layer, about 1 wt % to about 15 wt %, and for example, the binder may be present, based on the total weight of 100 wt % of the negative active material layer, at an amount of about 1 wt % or more, about 2 wt % or more, about 3 wt % or more, about 4 wt % or more, about 5 wt % or more, about 6 wt % or more, about 7 wt % or more, about 8 wt % or more, about 9 wt % or more, about 10 wt % or more, about 11 wt % or more, about 12 wt % or more, about 13 wt % or more, or about 14 wt % or more, and about 15 wt % or less, about 14 wt % or less, about 13 wt % or less, about 12 wt % or less, about 11 wt % or less, about 10 wt % or less, about 9 wt % or less, about 8 wt % or less, about 7 wt % or less, about 6 wt % or less, about 5 wt % or less, about 4 wt % or less, about 3 wt % or less, or about 2 wt % or less,

According to one embodiment, the binder may be present at an amount of about 1 wt % to about 14 wt %, or about 1 wt % to about 10 wt % based on the total weight of 100 wt % of the negative active material layer. In the negative active material layer, the mixing ratio of the negative active material and the binder may be at about a 99:1 to about a 60:40 weight ratio, about a 99:1 to about a 85:15 weight ratio, about a 99:1 to about an 86:14 weight ratio, or about a 99:1 to about a 90:10 weight ratio.

When including the binder at the amount of the above ranges in the negative active material layer, the electrical resistance and the adherence may be improved to increase characteristics (e.g., battery capacity and/or power characteristic) of the all solid battery.

The negative active material layer may further include additives, e.g., a conductive material, a filler, a dispersing agent, an ion conductive material, etc., in addition to the negative active material and the binder. The conductive material, which may be included in the negative active material layer, may be, for example, graphite, carbon black, acetylene black, ketjen black, carbon fiber, metal powder, etc. The filler, the dispersing agent, the ion conductive material, etc., which may be included in the negative active material layer, may be any suitable materials utilized (e.g., known) in the related art which are generally utilized in the all solid battery.

The negative active material layer may have a thickness of about 1 μm to about 20 μm. When the thickness of the negative active material layer is within the above range, suitable mechanical strength may be obtained without an increase in the irreversible capacity.

The positive electrode 13 may include a positive active material layer 132 on one side or both sides of the positive current collector 131. The positive current collector 131 may be (e.g., formed of) indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be a foil-type or a sheet type (e.g., in the form of a foil or a sheet).

The positive active material layer may include a positive active material. The positive active material may include compounds that reversibly intercalate and deintercalate lithium ions (e.g., capable of forming lithiated intercalation compounds). For example, the positive active material may include one or more composite oxides of a metal selected from cobalt, manganese, nickel, and a combination thereof, and lithium. Non-limiting examples of the positive active material may include (e.g., may be) LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤0.5); LiₐNi_{1-b-c}Co_{b}B¹_{c}D¹_{α} (0.90≤a≤1.8, 0≤b≤0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α}(0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂PO₄₃ (0≤f≤2); Li_{(3-f)} Fe₂PO₄₃ (0≤f≤2); and/or LiFePO₄.

In the chemical formulae, A is selected from Ni, Co, Mn, or a combination thereof; B¹ is selected from Al, Ni, Co, Mn, Cr, Fe, Mg, Sr, V, a rare earth element, or a combination thereof; D¹ is selected from O, F, S, P, or a combination thereof; E is selected from Co, Mn, or a combination thereof; F¹ is selected from F, S, P, or a combination thereof; G is selected from Al, Cr, Mn, Fe, Mg, La, Ce, Sr, V, or a combination thereof; Q is selected from Ti, Mo, Mn, or a combination thereof; I¹ is selected from Cr, V, Fe, Sc, Y, or a combination thereof; and J is selected from V, Cr, Mn, Co, Ni, Cu, or a combination thereof.

According to one embodiment, the positive active material may be a three-component-based lithium transition metal oxide such as LiNiₓCo_{y}Al_{z}O₂(NCA), LiNiₓCo_{y}Mn_{z}O₂(NCM) (herein, 0<x<1, 0<y<1, 0<z<1, x+y+z=1), etc.

The compounds (e.g., included in the positive active material) may have a coating layer on the surface thereof, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed (e.g., coated) in a method having no adverse influence on properties of a positive active material by utilizing these elements in the compound. For example, the method may include any suitable coating method such as spray coating, dipping, and/or the like, but is not illustrated in more detail because it is well-known in the related field.

Furthermore, the coating layer may include any coating materials which are suitable (e.g., known) as a coating layer for the positive active material of the all solid battery, and for example, may be Li₂O—ZrO₂ (LZO), etc.

When the positive active material includes a nickel containing three-component based active material such as NCA and/or NCM, the capacity density of the all solid battery may be further improved, and the elution of metal from the positive active material may be further reduced during the charging. Thus, the all solid battery may exhibit better (e.g., more improved) reliability and cycle-life characteristics in the charged state.

In some embodiments, the shape of the positive active material may be, for example, particle shapes such as a spherical shape and/or a non-spherical shape (e.g., in the form of particles). The average particle diameter of the positive active material may not be specifically limited, and may be in any suitable range which may be applied to a positive active material of the related art all solid secondary battery. The amount of the positive active material included in the positive active material may not be specifically limited, and may be in any suitable range which may be applied to a positive active material of the related art all solid secondary battery.

The positive active material layer may further include a solid electrolyte. The solid electrolyte included in the positive active material layer may be the aforementioned solid electrolyte, and may be the same as or different from the solid electrolyte included in the solid electrolyte layer. The solid electrolyte may be included in an amount of about 10 wt % to about 30 wt % based on the total weight of the positive active material layer.

The positive active material layer may further include additives such as a conductive material, a binder, a filler, a dispersing agent, an ion conductive material, etc., in addition to the aforementioned positive active material and the solid electrolyte.

The filler, the dispersing agent, and the ion conductive material, which are included in the positive active material layer, may be the same as the additives included in the negative active material layer. In some embodiments, the conductive material may be about 1 wt % to about 10 wt % with reference to the total of 100 wt % of the positive active material layer.

The binder which may be included in the positive active material may be, for example, styrene butadiene rubber (SBR), polytetrafluoroethylene, polyvinylidene fluoride, polyethylene, etc.

The thickness of the positive active material layer may be about 100 μm to about 200 μm. For example, the thickness of the positive active material layer may be about 100 μm or more, about 110 μm or more, about 120 μm or more, about 130 μm or more, about 140 μm or more, about 150 μm or more, about 160 μm or more, about 170 μm or more, about 180 μm or more, or about 190 μm or more, and about 200 μm or less, about 190 μm or less, about 180 μm or less, about 170 μm or less, about 160 μm or less, about 150 μm or less, about 140 μm or less, about 130 μm or less, about 120 μm or less, or about 110 μm or less. The thickness of the positive active material layer may be thicker than the thickness of the negative active material layer, and thus the capacity of the positive electrode may be larger than the capacity of the negative electrode.

The positive electrode may be prepared by forming a positive active material layer on a positive current collector utilizing a dry-coating and/or a wet-coating process.

The solid electrolyte layer 12 is interposed between the negative active material layer 112 and the positive active material layer 132. A solid electrolyte included in the solid electrolyte layer may be a sulfide-based solid electrolyte, and for example, an argyrodite (e.g., argyrodite-type) sulfide-based solid electrolyte. The sulfide-based solid electrolyte may be suitable, as it may exhibit better electrochemical characteristics within wider operation temperature ranges and good ionic conductivity compared to other solid electrolytes such as oxide-based solid electrolyte, etc.

The sulfide-based solid electrolyte may suitably (e.g., easily) form an electrode/electrolyte contact interface to exhibit good processability, compared to other solid electrolytes.

In one embodiment, the solid electrolyte may be Liₐ M_{b} P_{c}S_{d}Aₑ (where a, b, c, d, and e are each an integer of 0 or more, and 12 or less, M is Ge, Sn, Si, or a combination thereof, and A is F, Cl, Br, or I), and for example, the solid electrolyte may be Li₃PS₄, Li₇P₃S₁₁, or Li₆PS₅Cl.

Such a sulfide-based solid electrolyte may be prepared, for example, by a fusion quenching process and/or mechanical milling utilizing starting materials, such as Li₂S, P₂S₅, and/or the like. After the treating (e.g., after the fusion quenching process and/or mechanical milling), a heat treatment may be performed. The solid electrolyte may be amorphous, crystalline, or a combination thereof.

The sulfide-based solid electrolyte may be a commercial solid electrolyte.

The solid electrolyte layer may further include a binder. The binder may be styrene butadiene rubber, nitrile butadiene rubber, polytetrafluoroethylene, polyvinylidene fluoride, polyethylene, an acrylate-based polymer, or a combination thereof, and may be any suitable material which is generally utilized in the related art. The acrylate-based polymer may be poly(butyl acrylate), poly(methyl acrylate), poly(ethyl acrylate), poly(styrene-co-acrylic acid), or a combination thereof.

The solid electrolyte layer may be prepared by adding a solid electrolyte to a binder solution, coating it on a substrate film, and followed by drying. The binder solution may include isobutylyl isobutyrate, xylene, octyl acetate, or a combination thereof, as a solvent. An amount of the solid components in the binder solution may be about 0.5 wt % to about 4 wt %. A mixing ratio of the solid electrolyte and the binder may be about 96:4 to about 99.5:0.5 by weight ratio. The solid electrolyte layer preparation is widely known in the art, so a detailed description thereof will be omitted in the specification.

The solid electrolyte layer may have a thickness of about 10 μm to about 100 μm. When the thickness of the solid electrolyte layer is within the above range, suitable stiffness and flexibility may be exhibited, without an increase in resistance.

When the all solid battery according to one embodiment is charged, lithium ions are released from the positive active material and pass through the solid electrolyte to move to the negative electrode, and thus, deposited on the negative current collector to form a lithium deposition layer. That is, the lithium deposition layer may be formed between the negative current collector and the negative active material layer. As the repeated charging proceeds, the lithium deposition layer is formed between the negative current collector and the negative active material layer, and when discharging occurs, lithium may be moved back to the positive electrode. Thus, the volume of the negative electrode may be (e.g., repeatedly) enlarged and reduced, such that the total volume of the battery may be accordingly enlarged and reduced.

The charging may be a formation process which may be performed at about 0.1 C to about 0.2 C to about 4.2 V to about 4.5 V once to three times.

The lithium deposition layer may have a thickness of about 10 μm to about 50 μm. For example, the thickness of the lithium deposition layer may be about 10 μm or more, about 20 μm or more, about 30 μm or more, or about 40 μm or more, and about 50 μm or less, about 40 μm less, about 30 μm less, or about 20 μm less.

The buffer material 30 may be interposed between the cell stack 10 and the case 20 and when the cell stack 10 expands, the buffer material 30 is compressed (e.g., in the compressed state) to absorb the expansion of the cell stack 10, and when the cell stack 10 shrinks, the buffer material 30 expands (e.g., is in the expanded state) to pressurize the cell stack 10. That is, when the cell stack 10 shrinks in volume, the buffer material 30 expands accordingly and thereby exerting pressure on the cell stack 10. Thus, even though the cell stack 10 shrinks (e.g., in thickness), the cell stack 10 may be pressurized (e.g., pressed by the buffer material in the expanded state).

That is, the cell stack 10 includes the negative current collector 111, the negative active material layer 112, the solid electrolyte layer 12, the positive active material layer 132, and the positive current collector 131 to form a unit cell (UC), and a symmetric cell (SC) that is symmetric thereto (e.g., has symmetry around, for example, the negative current collector 111), and may repeatedly include (e.g., may include a plurality of) the unit cells and the symmetric cells. In some embodiments, the cell stack 10 includes a positive active material layer 132 on both sides of the positive current collector 131 and includes a negative active material layer 112 on both sides of the negative current collector 111.

In the first embodiment, the buffer material (e.g., the buffer material layer) 30 may be interposed between the inside of the case 20 (e.g., an inside surface of the case 20) and a current collector disposed at the outermost of the negative current collector 111 or the positive current collector 131. FIG. 1 shows a negative current collector 111 which is disposed at the outermost of the cell stack 10.

In some embodiments, the buffer material (e.g., the buffer material layer) 30 may be interposed between the negative current collector 111 and an inside of the case 20 (e.g., an inside surface of the case 20) facing thereto to absorb a final (e.g., overall) expansion and a shrinkage of the cell stack 10 due to each expansion and shrinkage of the unit cells (US) and the symmetrical cells (SC).

The buffer material 30 may have a thermo-responsiveness, and thus the thickness of the cell stack 10 is reduced when the cell stack 10 is prepared and heated at a temperature equal to or greater than a critical temperature. Accordingly, the assembly of the buffer material 30 and the cell stack 10 may be easily inserted into the case 20. After the cell stack 10 is inserted into the case 20, as the temperature of the cell stack 10 is decreased to less than the critical temperature, the buffer material 30 may expand in the expansion state to maintain the cell stack 10 in the case 20.

The buffer material 30, that is, a porous polymer material layer, may shrink and expand in thickness according to the temperature change to improve workability for inserting the cell stack into the case 20. Concurrently or simultaneously, the buffer material 30 allows continuous pressurization in order to maintain closely contact the negative and positive active material layers 112 and 132, and the solid electrolyte layer 12, in the cell stack 10 inserted into the case 20. That is, the buffer material (e.g., the buffer material layer) 30 maintains continuous contact among the negative active material layer 112 the solid electrolyte layer 12, and the positive active material layer 132 in the cell stack 10 inserted into the case 20.

Hereinafter, the second embodiment will be illustrated. The description of the same components as in the first embodiment will be omitted, and the different constructs thereto will be illustrated.

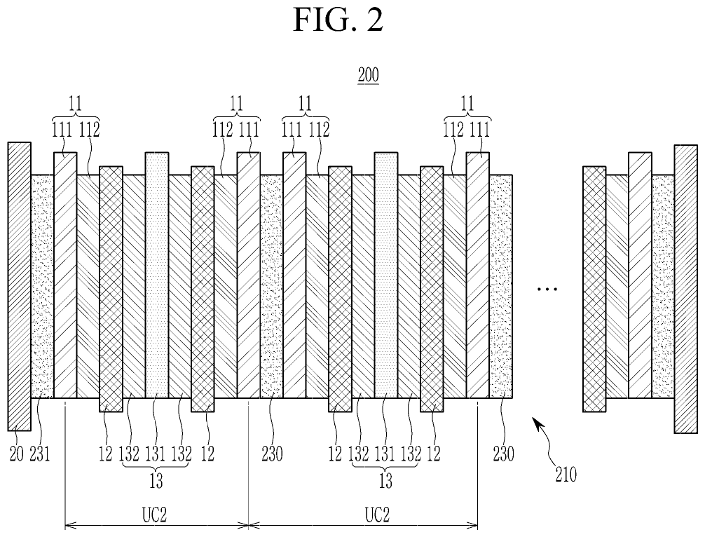

FIG. 2 is a cross-sectional view of the all solid battery according to the second embodiment. Referring to FIG. 2, in the all solid secondary battery according to the second embodiment, a buffer material (e.g., a buffer material layer) 230 may be interposed between the opposite sides of the negative active material layers 112 forming the two adjacent negative current collectors 111. For example, the buffer material (e.g., the buffer material layer) 230 may be interposed between two adjacent negative current collectors 111, on the side of each negative current collector 111 opposite to the side on which the negative active material layer 112 is formed.

That is, the cell stack 210 includes a negative current collector 111, a negative active material layer 112, a solid electrolyte layer 12, a positive active material layer 132, a positive current collector 131, a positive active material layer 132, a solid electrolyte layer 12, a negative active material layer 112 and a negative current collector 111 to form a unit cell (UC2), and may repeatedly include (e.g., may include a plurality of) the unit cells (UC2). The cell stack 210 includes a positive active material layer 132 on both sides of the positive current collector 131, and a negative active material layer 112 on one side of the negative current collector 111.

The buffer material (e.g., the buffer material layer) 230 may be interposed between two adjacent unit cells, UC2, that is, between two negative current collectors 111 of the two adjacent unit cells UC2. In this case, the buffer material 230 may absorb partial expansion and shrinkage according to expansion and shrinkage of each of the two unit cells (UC2), respectively. The buffer material (e.g., the buffer material layer) 231 may be interposed between the inside of the case 20 (e.g., the inside surface of the case 20) and the negative current collector 111 disposed at an outermost portion of the cell stack 210. The buffer material 231 may further finally absorb the remaining expansion and shrinkage in the unit cells (UC2). That is, the buffer material (e.g., the buffer material layer) 231 may further absorb any residual expansion and shrinkage in the unit cells (UC2) that is not absorbed by the buffer material (e.g., the buffer material layer) 230.

Such an all solid battery may be fabricated by laminating the buffer material layer, the negative electrode, the solid electrolyte, and the positive electrode in the structure shown in FIG. 1 or FIG. 2 to prepare an assembly of a cell stack and the buffer material layer, heat-treating the assembly to a temperature equal to or greater than a critical temperature of the thermo-responsive polymer included in the buffer material layer, i.e., about 50° C. to about 80° C., inserting the heat-treated product into a battery case, and sealing the battery case. Thereafter, as the prepared all solid battery is maintained at room temperatures, the temperature of the all solid battery may be decreased to a critical temperature of the thermo-responsive polymer or lower.

Changes in volume of the all solid battery during the above process, are described as follows: heat-treatment to the critical temperature of the thermo-response or greater allows a reduction of a total thickness of the assembly to be less than that of the case, and after sealing the battery case and when the temperature of the all solid battery is decreased to the critical temperature of the thermo-responsive polymer or lower (during maintenance or storage at room temperature), the total thickness of the assembly is enlarged (e.g., increased). Herein, as the battery case is sealed, the battery case constrains the expansion of the assembly in the thickness direction, therefore, an inner pressure of the battery may be increased to make compact (e.g., close) contact among the negative electrode, the solid electrolyte, and the positive electrode.

Hereinafter, examples of the present disclosure and comparative examples are described. These examples, however, are not in any sense to be interpreted as limiting the scope of the disclosure.

### Example 1

### 1. Preparation of Positive Electrode

100 parts by weight of anhydrous 2-propanol, 10 parts by weight of lithium methoxide (10% methanol solution), and 0.5 parts by weight of zirconium(IV) tetrapropoxide were mixed to prepare an LZO coating solution. LiNi_{0.9}Co_{0.05}Mn_{0.05}O₂ was admixed to the LZO coating solution and agitated for 1 hour, followed by vacuum-drying at 50° C. to prepare a LZO-coated positive active material.

The LZO-coated positive active material LiNi_{0.9}Co_{0.05}Mn_{0.05}O₂, an argyrodite solid electrolyte Li₆PS₅Cl, a carbon nanofiber conductive material, and a polytetrafluoroethylene binder were mixed in an N-methylpyrrolidone solvent to prepare a positive active material slurry. In the positive active material slurry, the weight ratio of the positive active material, the solid electrolyte, the conductive material, and the binder was 85:15:3:1.5.

The positive active material slurry was coated on an aluminum foil, and dried and compressed in a general method to prepare a positive electrode having a thickness of 120 μm in which a positive active material had a thickness of 105 μm.

### (2) Preparation of Solid Electrolyte Layer

To an argyrodite solid electrolyte Li₆PS₅Cl, an isobutylyl isobutyrate binder solution (solid amount: 8 wt %) added with poly(butyl acrylate) was added and mixed therewith. The mixing ratio of the solid electrolyte and the binder was 99:1 by weight ratio.

The mixing was performed by utilizing a Thinky mixer. The obtained mixture was added with 2 mm zirconia balls and was repeatedly mixed with the Thinky mixer to prepare a slurry. The slurry was casted on a release polytetrafluoroethylene film and dried at room temperature to prepare a solid electrolyte layer with a thickness of 100 μm.

### (3) Preparation of Negative Electrode

Polyvinylidene fluoride was dissolved in an N-methyl pyrrolidone solvent to prepare a binder solution with a solid amount of 7 wt %.

The binder solution, Ag nanoparticles (D50: 60 nm) and carbon black were mixed. The carbon black was utilized as secondary particles having a particle diameter of 275 nm in which primary particles having a particle diameter of 76 nm were assembled. The mixing ratio of carbon black and Ag nanoparticles was 75:25 by weight ratio, and the mixing ratio of a mixture of Ag nanoparticles and carbon black, and polyvinylidene fluoride, was 93:7 by weight ratio.

The mixture was agitated with the Thinky mixer to suitably control viscosity. After controlling viscosity, 2 mm zirconia balls were added thereto and it was again agitated to prepare a slurry. The agitated slurry was coated on a stainless steel foil current collector and vacuum dried at 100° C. to prepare a negative electrode having a negative active material layer with a thickness of 10 μm and the current collector. The negative electrode had a thickness of 20 μm and the amount of the binder in the negative active material layer was 7 wt % based on the total amount, 100 wt % of the negative active material layer.

### (4) Preparation of Buffer Material Layer

Poly(N-ethylmethacrylamide) with a critical temperature of 58° C. was added to a propanol solvent to prepare a buffer solution, cast on a release polytetrafluoroethylene film, and then dried at room temperature to form a buffer material layer with a thickness of 200 μm.

### (4) Preparation of all Solid Battery

The prepared buffer material layer, the negative electrode, the solid electrolyte and the positive electrode were stacked in the structure shown in FIG. 1 to prepare an assembly of a cell stack and a buffer material layer. The assembly was heat-treated at 60° C., and the heat-treated product was inserted into a battery case to fabricate an all solid cell.

### Example 2

The above prepared buffer material layer, the negative electrode, the solid electrolyte, and the positive electrode were stacked in the structure shown in FIG. 2 to prepare an assembly of a cell stack and a buffer material layer. The assembly was heat-treated at 60° C., and the heat-treated product was inserted into a battery case to fabricate an all solid cell.

### Comparative Example 1

An all solid cell was fabricated by the same procedure as in Example 1, except that a polytetrafluoroethylene film was utilized as the buffer material layer.

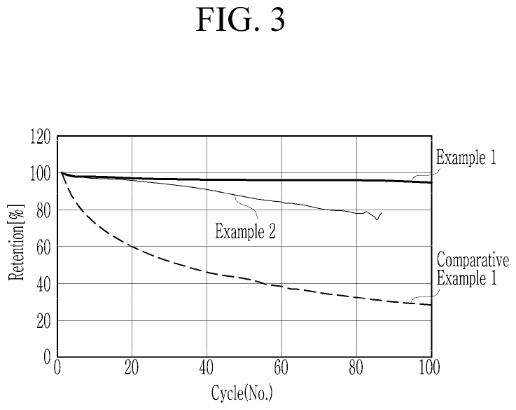

The all solid cells according Examples 1 and 2 and Comparative Example 1 were charged and discharged at a condition of 0.33 C, an upper-voltage of 4.25 V, and a lower-voltage of 2.5 V, 100 times. The ratio of the 100th discharge capacity to the 1st discharge capacity was measured, and the results are shown in FIG. 3 as a capacity retention ratio. As shown in FIG. 3, the capacity retention of each of the all solid cells according to Examples 1 and 2 was substantially better than that according to Comparative Example 1.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims, and equivalents thereof.

Description of symbols

| | |
|---|---|
| 10, 210: Cell stack | 11: Negative electrode |
| 12: Solid electrolyte layer | 13: Positive electrode |
| 20: Case | 30, 230, 231: Buffer material (e.g., |
| | buffer material layer) |
| 100, 200: All solid secondary battery | 111: Negative current collector |
| 112: Negative active material layer | 132: Positive active material layer |
| 131: Positive current collector | SC: Symmetric cell |
| UC, UC2: Unit cell | |

What is claimed is:

1. An all solid battery, comprising:
a cell stack comprising a negative electrode, a solid electrolyte layer, and a positive electrode;
a case to accommodate the cell stack; and
a buffer material to pressurize the cell stack in the case.

2. The all solid battery of claim 1, wherein the buffer material is a thermo-responsive porous polymer sheet.

3. The all solid battery of claim 1, wherein the buffer material comprises a thermo-responsive polymer having a critical temperature of about 50° C. to about 80° C.

4. The all solid battery of claim 3, wherein the thermo-responsive polymer is selected from poly(N-ethylmethacrylamide), poly(propylene glycol), poly(N-cyclopropylacrylamide), or a combination thereof.

5. The all solid battery of claim 1, wherein the buffer material is between the cell stack and the case.

6. The all solid battery of claim 5, wherein
the negative electrode comprises a negative current collector and a negative active material layer on one side or both sides of the negative current collector,
the positive electrode comprises a positive current collector and a positive active material layer on one side or both sides of the positive current collector,
the solid electrolyte layer is between the negative active material layer the positive active material layer, and
the buffer material is between an outermost current collector of the cell stack and an inside surface of the case.

7. The all solid battery of claim 1, wherein
the negative electrode comprises a negative current collector and a negative active material layer on one side of the negative current collector and not on an opposite side of the negative current collector,
the positive electrode comprises a positive current collector and a positive active material layer on both sides of the positive current collector,
the solid electrolyte layer is between the negative active material layer and the positive active material layer, and
the buffer material is between the opposite sides of two adjacent negative current collectors.

8. The all solid battery of claim 7, wherein the buffer material is further between an outmost negative current collector and an inside surface of the case.

9. A method of manufacturing the all solid battery of claim 1, the method comprising:
assembling the buffer material with the cell stack, the buffer material having a critical temperature,
heating the cell stack to a temperature greater than the critical temperature of the buffer material to cause a volume change of the buffer material,
inserting the cell stack into the case,
sealing the cell, and
decreasing the temperature of the cell stack to less than the critical temperature of the buffer material.

10. The method of manufacturing the all solid battery of claim 9, wherein the critical temperature of the buffer material is about 50° C. to about 80° C.

11. The method of manufacturing the all solid battery of claim 9, wherein the buffer material comprises poly(N-ethylmethacrylamide), poly(propylene glycol), poly(N-cyclopropylacrylamide), or a combination thereof.
